(19) United States
(12) Patent Application Publication
(10) Pub. No.: US 2025/0007951 A1
(43) Pub. Date: Jan. 2, 2025

(54) SECURE, APPLICATION-AWARE ROUTING

(71) Applicant: Cisco Technology, Inc., San Jose, CA (US)

(72) Inventors: Prab Radhakrishnan, Dublin, CA (US); Balaji Sundararajan, Fremont, CA (US); Ram Dular Singh, Cupertino, CA (US); Vishnuprasad Raghavan, Sammamish, WA (US)

(21) Appl. No.: 18/215,644

(22) Filed: Jun. 28, 2023

(51) Int. Cl. H04L 9/40; H04L 45/42

(52) U.S. Cl. CPC H04L 63/20; H04L 45/42; H04L 63/0876

(57) ABSTRACT

Techniques for extending application-aware routing (AAR) policies to enable intelligent routing decisions based on device security posture. The techniques may include receiving, from a client device, traffic that is to be sent over a network to an application and determining a security score associated with the traffic. The security score may be based on a security posture associated with the client device, a security level associated with a connectivity network used by the client device, and the like. The techniques may also include determining, based at least in part on the security score and based at least in part on an application-aware routing policy, a path for sending the traffic to the application.

### TECHNICAL FIELD

The present disclosure relates generally to techniques for, among other things, extending application-aware routing (AAR) policies to enable intelligent routing decisions based on device security posture and/or the security level of the network used to connect.

### BACKGROUND

Identity-based security policies assume that a user identity or device identity is enough to establish a policy decision. However, the same user or device can have a dynamic nature as the user can login to a system using different devices or even from different networks. As such, for a device-based security policy, the device can sometimes go out of compliance without consequence. In modern network architectures, such as a software-defined wide area network (SD-WAN), vendors generally define application data traffic steering policies based on application service level agreements (SLAs) and/or service level objectives. As such, a path taken by application data traffic through a network can be optimized by directing the application data traffic to wide area network (WAN) links that support the required levels of packet loss, latency, jitter, or other metrics defined in an application's SLA. Due to the use of identity-based security policies in these architectures, non-compliant application data traffic can be sent over links intended for security-compliant traffic.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example architecture in which various aspects of the techniques disclosed herein may be performed to extend application-aware routing (AAR) policies to enable intelligent routing decisions based on device security posture.

FIG. 2 illustrates another example architecture in which various aspects of the techniques disclosed herein may be performed.

FIG. 3 is a pictorial flow diagram illustrating an example method associated with the techniques described herein.

FIG. 4 is a flow diagram illustrating an example method associated with the techniques described herein.

FIG. 5 is a block diagram illustrating an example packet switching system that can be utilized to implement various aspects of the technologies disclosed herein.

FIG. 6 is a block diagram illustrating certain components of an example node that can be utilized to implement various aspects of the technologies disclosed herein.

FIG. 7 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This application is directed to techniques for extending application-aware routing (AAR) policies to enable intelligent routing decisions based on device security posture and/or the security level of the network used to connect. By way of example, and not limitation, a method according to the techniques disclosed herein may include receiving, from a client device, traffic that is to be sent over a network to an application. In some examples, a security score associated with the traffic may be determined, as well as a path for sending the traffic to the application. In some examples, the path may be determined based at least in part on the security score and based at least in part on an application-aware routing policy. In some examples, the method may include causing the traffic to be sent to the application via the path.

Additionally, the techniques described herein may be performed as a method and/or by a system having non-transitory computer-readable media storing computer-executable instructions that, when executed by one or more processors, performs the techniques described above and herein.

### Example Embodiments

As noted above, a user or device can have a dynamic nature and, as a result, the user or device can sometimes go out of compliance with respect to an identity-based security policy. Due to the use of identity-based security policies in application-aware routing architectures, non-compliant application data traffic can be sent over links intended for security-compliant traffic. That is, as a security posture of a device changes from being in compliance to being non-compliant, the security policy is unable to detect the non-compliance issue and may continue to allow application data traffic to be sent over a less optimal network path, in terms of security and/or networking performance.

This application is directed to techniques for extending application-aware routing (AAR) policies to enable intelligent routing decisions based on device security posture and/or the security level of the network used to connect. For example, traffic (e.g., application data traffic) may be received from a client device that is to be sent over a network to an application. In examples, a security score associated with the traffic may be determined. For instance, the security score may be indicative of a security posture of the client device (e.g., whether the client device is a trusted device, untrusted device, enterprise managed device, etc.), a security level of a network used by the client device to connect (e.g., whether the client device is utilizing a public network or a private network to connect), an IP address associated with the client device, an identity of a user of the client device, a user's entitlements, and/or the like. In examples, a traffic signature associated with the traffic may be determined. For instance, the traffic signature may be indicative of a type of the client device (e.g., desktop computer, laptop, cell phone, etc.) or a type of the traffic (e.g., video traffic, voice/audio traffic, web traffic, etc.). Based at least in part on the security score, the traffic signature, and/or an application-aware routing policy associated with the network, a path for sending the traffic to the application may be selected or otherwise determined, and the traffic may accordingly be sent along that path. In examples, the path may be an optimal path in terms of security, network performance, application performance, and/or the like.

For example, when a user utilizes a managed device (e.g., enterprise managed device) to connect to an enterprise network from a branch office, the policy applied on the user's traffic may be to route trusted application traffic (e.g., trusted software-as-a-service (SaaS) application traffic) directly to the internet from the branch office. However, when the same user uses an unmanaged device (e.g., a personal phone or a personal computer) from the branch office, the security posture identification of that unmanaged device may lead to a different policy being applied on the traffic. For instance, traffic in this case may be redirected to a security function (e.g., a cloud security service, firewall, etc.) for further inspection before being sent to the destination. Such functionality may not be possible without a security posture analysis of the user's traffic. As another example, a remote access user may use a private home network or a public network (e.g., from a coffee shop or an airport terminal) to connect, and based on a security posture analysis of their traffic, this information may be leveraged to dynamically alter the routing policy to add more security services and/or functions to inspect the traffic when accessing applications from an untrusted network.

Based on the configuration of the network's routing policy and the determined security score of a traffic source (e.g., client device), traffic from an enterprise branch can be routed to an application access or to more security inspection services. When a device is trying to access an application (e.g., Office 365) or some resource in a data center, a path for the traffic may be determined based on the device's security score. For example, if the device has a low security score or access originates from an unsecured network, the traffic may be routed to a cloud security service or other security function for further analysis before access to the requested application is provided. That is, as an example, a policy may be written to allow access to critical services only if the security score meets a defined threshold, and all other traffic may be sent to the cloud or other security function for further analysis. In some examples, identity providers (e.g., Cisco Identity Services Engine (ISE), Microsoft Enterprise Mobility+Security, One Identity Manager, etc.) and/or other endpoint security tools may generate or otherwise determine the security scores described herein, which can be leveraged to provide a more dynamic policy (e.g., application-aware routing policy) for routing and security.

In some examples, the techniques disclosed herein may determine and make use of traffic signatures for enforcing routing decisions and policy. For example, when a user—even a user having a high security score—accesses a resource which leads to a match in a configured signature list, this specific flow can be subject to further security actions and/or functions (e.g., by service chaining with a firewall or forwarding to a cloud security service for inspection). This makes the application-aware policies more dynamic by not restricting the policy simply to the IP address or the user, but by varying the policy actions based the type of device used (e.g., phone, computer, etc.) or the kind of traffic in question (e.g., video, voice/audio, web, etc.).

According to the techniques disclosed herein, several advantages in network security, application-aware routing, and computer-related technology may be realized. For instance, the techniques disclosed herein may be utilized to determine whether a traffic signature matches a known vulnerability or data loss, and the traffic may be sent through a service chain and/or to a security cloud automatically and skip traditional application-aware routed paths. Additionally, a security score can be dynamically determined for traffic and a path for the traffic can be selected, which improves upon traditional application-aware routing. In other words, the techniques disclosed herein extend application-aware routing policies to enable more intelligent routing decisions to be made based on device security posture, traffic signatures, the security level of the network used to connect, etc., such that application-aware routing decisions can be made for sending traffic to an application without violating a network security policy or otherwise compromising security. Other improvements and advantages in network security, application-aware routing, and computer-related technology will be readily apparent to those having ordinary skill in the art.

By way of example, and not limitation, a method according to the techniques disclosed herein may include receiving a routing policy associated with a network. For instance, the routing policy may be received at an edge node (e.g., WAN edge router(s)) of the network (e.g., enterprise network) and from a management plane and/or a control plane associated with the network. In some examples the routing policy may be an Application-Aware Routing (AAR) policy that allows a network (e.g., SD-WAN) fabric to monitor the quality of network paths in real-time and do service level agreement (SLA)-driven routing across the best available transports. Such an AAR policy may allow the edge node(s) to consider the performance characteristics of the available overlay tunnels when making network path decisions for given application traffic. Additionally, or alternatively, in some examples the routing policy may be a security policy (e.g., group or identity-based entitlements) or another type of routing policy defining the action(s) to apply on various traffic (e.g., routing based on tunnel performance characteristics such as latency, jitter, etc.).

In some examples, the method may include receiving, from a client device, traffic that is to be sent to an application. In examples, the traffic may be received from the client device at the edge node of the network, and the edge node may be responsible for forwarding the traffic over another network (e.g., a wide area network) to the application. For instance, the application may be a cloud-delivered software as a service (SaaS) application. While several examples disclosed herein describe the traffic as being sent to the application, it is to be understood that the application may be any service or endpoint, such as a datacenter-provided or a cloud-provided resource, a remote service, or the like.

In some examples, the method may include receiving or otherwise determining a security score associated with the traffic. In some examples, the edge node may determine the security score associated with the traffic by utilizing an identity provider service. For instance, when the client device authenticates or otherwise gains access to the network, the identity provider service may perform a security posture analysis of the traffic (e.g., using a security analysis service, using its own knowledge and resources, etc.). As an example, if the client device is a remote access client device or otherwise accessing the network (e.g., the enterprise network) from a remote location (e.g., home office, public network, etc.), a headend node of the network (e.g., VPN concentrator, remote-access headend, SSL headend, etc.) may invoke the identity provider to authenticate/authorize the client device for access to the network. In examples, at this time of authorization/authentication the identity provider may generate the security score by analyzing the security posture of the client device. As an additional, or alternative, example, the edge node may invoke the identity provider to determine the security score when the edge node receives the traffic that is to be sent to the application over the wide area network.

In some examples, the security score may be based at least in part on one or more of a security posture of the client device, a security level of a connectivity network utilized by the client device, or the like. For instance, a value of the security score may vary based at least in part on whether the client device is a trusted device or an untrusted device, whether the client device is utilizing a trusted network or an untrusted network (or public network versus private network), a user of the client device (e.g., admin, engineer, human resources, etc.), and/or the like. As an example, traffic originating from an unmanaged device that is using a public network may receive a low security score, traffic originating from a managed device using the public network (or an unmanaged device using a private/trusted network) may receive a medium security score, and traffic originating from a managed device using a trusted network (e.g., remote enterprise managed network) may receive a high security score.

In some examples, a security score may be associated or linked to a user identity, an IP address of the client device, or another identifier associated with the client or the user. For instance, the security score may be entered and/or stored in a table, where a first entry in the table is the security score, a second entry in the table is a user identifier, and a third entry in the table is a network address (e.g., IP address). In some examples, this association of the security score with the user or device identifier and/or the network address may be made by the identity provider and passed to the control plane and/or management plane associated with the network.

In some examples, the security scores for individual client devices may be distributed to the control plane associated with the network. In this way, the control plane may store the security scores for various client devices and/or distribute the security scores to other edge nodes or other points in the enterprise network. In examples, the control plane may utilize the security scores to assist the edge nodes in making routing decisions for traffic.

In some examples, a traffic signature associated with the traffic may be determined. For instance, the edge node may determine the traffic signature associated with the traffic for enforcing routing actions. In some examples, the traffic signature may be indicative of a type of the client device (e.g., desktop computer, laptop, cell phone, etc.) or a type of the traffic (e.g., video traffic, voice/audio traffic, web traffic, etc.). In examples, the traffic signature may be correlated with previous traffic signatures when determining the policy action to be applied for the traffic. For example, when a user—even a user having a high security score—accesses a resource which leads to a match in a configured signature list, this specific flow can be subject to further security actions and/or functions (e.g., by service chaining with a firewall or forwarding to a cloud security service for inspection). This makes the application-aware policies more dynamic by not restricting the policy simply to the IP address or the user, but by varying the policy actions based the type of device used (e.g., phone, computer, etc.) or the kind of traffic in question (e.g., video, voice/audio, web, etc.).

In some examples, the method may include determining a path for sending the traffic to the application. In some examples, the path may be determined or selected based at least in part on the security score, the traffic signature, and/or the routing policy. In other words, the security score and/or the traffic signature may be used as an input and/or factor as part of the routing policy to determine how the traffic should be sent to the application. This allows the routing policy to be extended to factor in security measures. In some examples, based on the security score and/or the traffic signatures, a decision may be made to forego sending the traffic across and application-aware (e.g., SLA-based) path to the application. For instance, a policy may be written to allow access to critical services only if the security score meets a defined threshold, and all other traffic (e.g., not having a security score meeting the threshold) may be sent to the cloud or other security function for further analysis. In some examples, the path for sending the traffic may be determined by one or more of the edge node(s), the control plane of the network, or the like.

In some examples, the path used to send the traffic to the application may vary based on the security score, traffic signature, and/or the policy. For instance, traffic having a security score that meets or exceeds a threshold value (e.g., a high security score) may be sent to the application via a direct path (e.g., an optimal, application-aware path). Additionally, traffic having a security score that is less than the threshold value (e.g., a low security score) and/or between a first threshold value and a second threshold value (e.g., a medium security score) may be sent to the application via a path that includes one or more security functions or services (e.g., firewall, IDS, IPS, cloud-delivered security service, etc.). In some examples, the path(s) chosen even when a security score is not a high security score may still be an application-aware path, but the path may include some form of security measures.

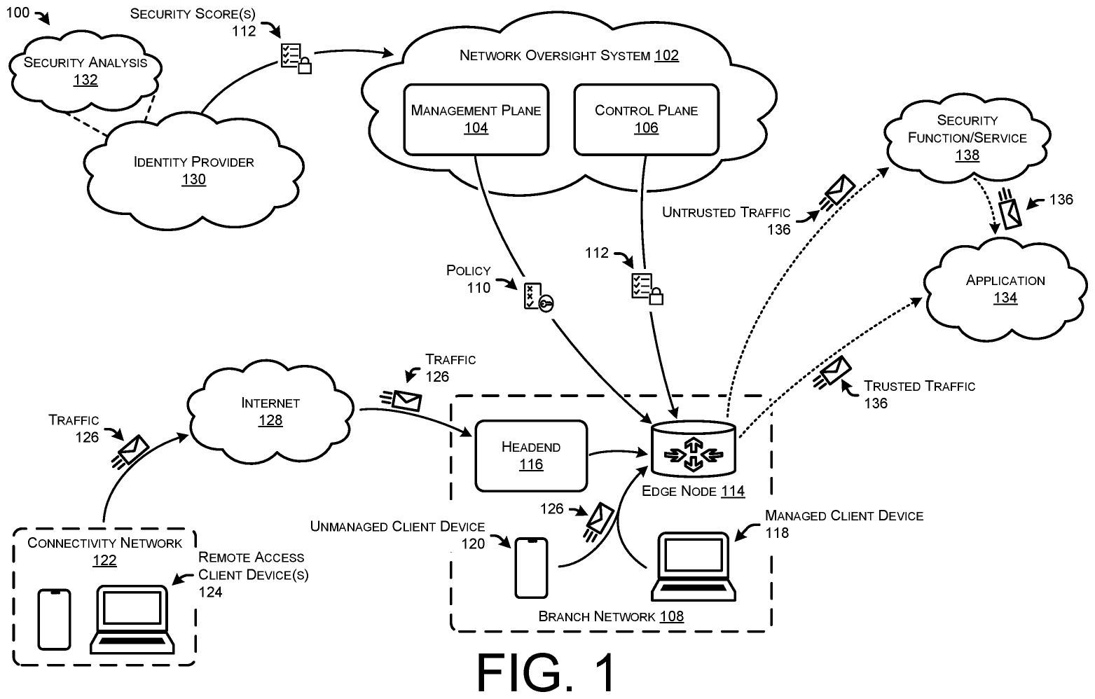

FIG. 1 illustrates an example architecture 100 in which various aspects of the techniques disclosed herein may be performed to extend application-aware routing (AAR) policies to enable intelligent routing decisions based on device security posture. The architecture 100 includes a network oversight system 102, which includes a management plane 104 and a control plane 106. The network oversight system 102 may oversee operations taking place in the branch network 108, which may represent an enterprise network. In some examples, the management plane 104 may be utilized to create policies, such as the policy 110, for directing routing decisions taking place in the branch network 108. Additionally, the control plane 106 may distribute security score(s) 112 to the branch network to be used in making the routing decisions.

The branch network 108 may include an edge node 114 (e.g., WAN edge node or router(s)) and a headend 116. In examples, the branch network 108 may provide an appropriate local area network (LAN) for providing connectivity to client devices, such as the managed client device 118 (e.g., an enterprise managed device) and the unmanaged client device 120 (e.g., a personal device of a user). In examples, the client devices within the branch network 108 may be able to skip the headend 116 and send their traffic 126 directly to the edge node 114.

The architecture 100 also includes a connectivity network 122. The connectivity network may be a public network or a private network. For instance, the connectivity network 122 may be a public LAN (e.g., Wi-Fi network) at a coffee shop, airport terminal, transportation system (e.g., plane, train, vehicle), library, or the like for providing individuals with network connectivity. Additionally, or alternatively, the connectivity network 122 may be a private network such as a home office LAN, a remote branch office network, or the like. In examples, one or more remote access client device(s) 124 may establish a connection (e.g., secure communication session, VPN connection, SSL connection, ZTNA connection, etc.) with the headend 116 of the branch network 108 to send traffic 126 to the branch network 108 over the internet 128 (or another suitable WAN network).

The architecture 100 also includes an identity provider 130. The identify provider may include or otherwise utilize a security analysis component/service 132 to determine the security score(s) 112 associated with the traffic 126. For instance, when a client device connects to the branch network 108, the identity provider 130 may identify and authenticate/authorize the client device and/or a user of the client device. During this phase, the identity provider 130 may utilize the security analysis component/service 132 to generate a security score associated with the traffic 126. In examples, the security score may be based on a security posture of the client device, a security level of the network used by the client device to connect (e.g., the connectivity network 122 or the branch network 108), the type of traffic being sent, the kind of client device, and/or the like.

In examples, when the edge node 114 receives the traffic 126, the edge node 114 may utilize the policy 110 and the security score(s) 112 to determine a path for sending the traffic to an application 134 (e.g., a SaaS application, a cloud-delivered or datacenter-delivered resource, etc.). For instance, the edge node 114 may send trusted traffic 136 to the application 134 via a direct path, and send untrusted traffic 136 to the application 134 via a path that includes a security function/service 138 (e.g., firewall, IDS, IPS, cloud-delivered security service, etc.).

In some examples, the policy 110 may be an Application-Aware Routing (AAR) policy that allows a network (e.g., SD-WAN) fabric to monitor the quality of network paths in real-time and do service level agreement (SLA)-driven routing across the best available transports. Such an AAR policy may allow the edge node 114 to consider the performance characteristics of the available overlay tunnels when making network path decisions for given application traffic 126. Additionally, or alternatively, in some examples the policy 110 may be a security policy (e.g., group or identity-based entitlements) or another type of routing policy defining the action(s) to apply on the traffic 126 (e.g., routing based on tunnel performance characteristics such as latency, jitter, etc.).

In some examples, when the edge node 114 receives the traffic 126, the edge node 114 may determine the security score 112 associated with the traffic 126. In some examples, the security score 112 may be received by the edge node 114 from the identity provider 130 and/or the network oversight system 102. For instance, when the client device authenticates or otherwise gains access to the branch network 108, the identity provider 130 may perform a security posture analysis of the traffic 126 (e.g., using the security analysis service 132, using its own knowledge and resources, etc.). As an example, if the client device is a remote access client device 124 or otherwise accessing the branch network 108 from a remote connectivity network 122, the headend 116 (e.g., VPN concentrator, remote-access headend, SSL headend, etc.) of the branch network 108 may invoke the identity provider 130 to authenticate/authorize the client device. In examples, at this time of authorization/authentication the identity provider may generate the security score 112 by analyzing the security posture of the client device. As an additional, or alternative, example, the edge node 114 may invoke the identity provider 130 to determine the security score 112 when the edge node 114 receives the traffic 126 that is to be sent to the application 134 over the wide area network.

In some examples, the security score(s) 112 may be based at least in part on one or more of a security posture of the client device, a security level of the connectivity network 122 utilized by the client device, or the like. For instance, values of the security score(s) 112 may vary based at least in part on whether the client device is a trusted device or an untrusted device, whether the client device is utilizing a trusted network or an untrusted network (or public network versus private network), a user of the client device (e.g., admin, engineer, human resources, etc.), and/or the like. As an example, traffic originating from an unmanaged device that is using a public network may receive a low security score, traffic originating from a managed device using the public network (or an unmanaged device using a private/trusted network) may receive a medium security score, and traffic originating from a managed device using a trusted network (e.g., remote enterprise managed network) may receive a high security score.

In some examples, the security score(s) 112 for individual client devices may be distributed to the control plane 106 associated with the network. In this way, the control plane 106 may store the security score(s) 112 for various client devices and/or distribute the security score(s) 112 to other edge nodes or other points in the enterprise network. In examples, the control plane 106 may utilize the security score(s) 112 to assist the edge node 114 in making routing decisions for the traffic 126.

In some examples, a traffic signature associated with the traffic 126 may additionally, or alternatively, be determined. For instance, the edge node 114 may determine the traffic signature associated with the traffic 126 for enforcing routing actions. In some examples, the traffic signature may be indicative of a type of the client device (e.g., desktop computer, laptop, cell phone, etc.) or a type of the traffic 126 (e.g., video traffic, voice/audio traffic, web traffic, etc.). In examples, the traffic signature may be correlated with previous traffic signatures when determining the policy action to be applied for the traffic 126. For example, when a user—even a user having a high security score—accesses a resource (e.g., application 134) which leads to a match in a configured signature list, this specific flow can be subject to further security actions and/or functions (e.g., by sending to the security function/service 138). This makes the application-aware policies more dynamic by not restricting the policy simply to the IP address or the user, but by varying the policy actions based the type of device used (e.g., phone, computer, etc.) or the kind of traffic 126 in question (e.g., video, voice/audio, web, etc.).

In some examples, the edge node 114 may dynamically determine a path for sending the traffic 126 to the application 134. In some examples, the path may be determined or selected based at least in part on the security score(s) 112, the traffic signature(s), and/or the policy 110. In other words, the security score(s) 112 and/or the traffic signature(s) may be used as an input and/or factor as part of the policy 110 to determine how the traffic 126 should be sent to the application 134. This allows the policy 110 to be extended to factor in security measures. In some examples, based on the security score(s) 112 and/or the traffic signatures, a decision may be made to forego sending the traffic 126 across and application-aware (e.g., SLA-optimized) path to the application 134. For instance, the policy 110 may be written to allow access to critical services only if the security score meets a defined threshold, and all other traffic (e.g., not having a security score meeting the threshold) may be sent to the security function/service 138 for further analysis. In some examples, the path for sending the traffic 126 to the application 134 may be determined by the edge node 114, the network oversight system 102 (or the management plane 104 or control plane 106 components therein), and/or the like.

In some examples, the path used to send the traffic 126 to the application 134 may vary based on the security score, traffic signature, and/or the policy. For instance, traffic 126 having a security score that meets or exceeds a threshold value (e.g., a high security score) may be sent to the application 134 via the direct path (e.g., an optimal, application-aware path). Additionally, traffic having a security score that is less than the threshold value (e.g., a low security score) and/or between a first threshold value and a second threshold value (e.g., a medium security score) may be sent to the application 134 via the security function/service 138. In some examples, the path(s) chosen even when a security score is not a high security score may still be an application-aware path, but the path may include some form of security measures.

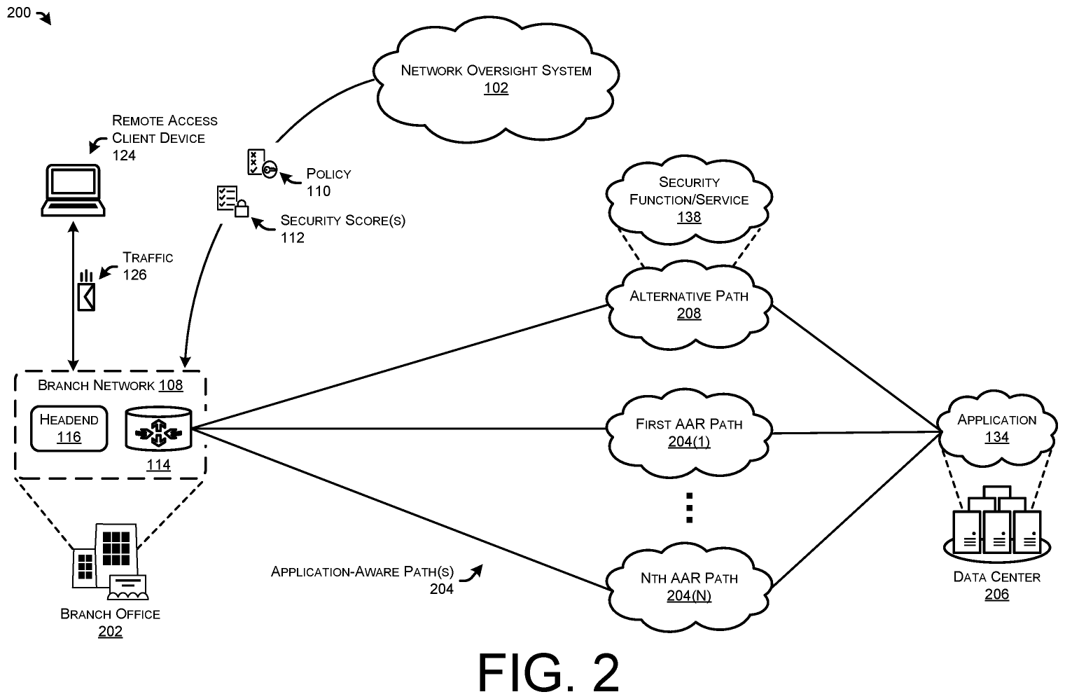

FIG. 2 illustrates another example architecture 200 in which various aspects of the techniques disclosed herein may be performed. The architecture 200 includes a branch office 202 that provides the branch network 108. The architecture 200 also includes a data center 206. The data center 206 may include various computing resources for hosting the application 134. In some examples, the data center 206 may be associated with a cloud-provider.

FIG. 2 includes additional detail illustrating different application-aware paths(s) 204 that may be selected for sending the traffic 126 to the application 134. For instance, the application-aware path(s) 204 include at least a first AAR path 204(1) and an Nth path 204(N) (where “N” may represent any number). Also illustrated is an alternative path 208, which includes the security function/service 138. In some examples, such as when untrusted traffic having a low security score is sent to the application 134, the alternative path 208 may be used instead of one of the application-aware path(s) 204.

As shown in FIG. 2, the policy 110 and the security score(s) 112 may be received at the branch network 108 from the network oversight system. In some examples, the policy 110 may be an Application-Aware Routing (AAR) policy that allows a network (e.g., SD-WAN) fabric to monitor the quality of network paths in real-time and do service level agreement (SLA)-driven routing across the best available transports. Such an AAR policy may allow the edge node 114 to consider the performance characteristics of the available overlay tunnels when making network path decisions for given application traffic 126.

In some examples, when the edge node 114 receives the traffic 126 (from the remote access client device 124 via the headend 116, the edge node 114 may determine the security score 112 associated with the traffic 126. Additionally, in some examples, the edge node 114 may determine a traffic signature associated with the traffic 126. In some examples, the traffic signature may be indicative of a type of the client device (e.g., desktop computer, laptop, cell phone, etc.) or a type of the traffic 126 (e.g., video traffic, voice/audio traffic, web traffic, etc.). In examples, the traffic signature may be correlated with previous traffic signatures when determining the policy action to be applied for the traffic 126. For example, when a user—even a user having a high security score—accesses a resource (e.g., application 134) which leads to a match in a configured signature list, this specific flow can be subject to further security actions and/or functions (e.g., by sending to the security function/service 138). This makes the application-aware policies more dynamic by not restricting the policy simply to the IP address or the user, but by varying the policy actions based the type of device used (e.g., phone, computer, etc.) or the kind of traffic 126 in question (e.g., video, voice/audio, web, etc.).

In some examples, the edge node 114 may dynamically determine or select a path for sending the traffic 126 to the application 134. In some examples, the specific path may be determined or selected based at least in part on the security score(s) 112, the traffic signature(s), and/or the policy 110. In other words, the security score(s) 112 and/or the traffic signature(s) may be used as an input and/or factor as part of the policy 110 to determine how the traffic 126 should be sent to the application 134. This allows the policy 110 to be extended to factor in security measures. In some examples, based on the security score(s) 112 and/or the traffic signatures, a decision may be made to forego sending the traffic 126 across one of the application-aware path(s) 204 to the application 134 and, instead, send the traffic 126 across the alternative path 208 including the security function/service 138. For instance, the policy 110 may be written to allow access to critical services only if the security score meets a defined threshold, and all other traffic (e.g., not having a security score meeting the threshold) may be sent over the alternative path 208 for further analysis. In some examples, the path for sending the traffic 126 to the application 134 may be determined by the edge node 114, the network oversight system 102 (or the management plane 104 or control plane 106 components therein), and/or the like.

In some examples, the path used to send the traffic 126 to the application 134 may vary based on the security score, traffic signature, and/or the policy. For instance, traffic 126 having a security score that meets or exceeds a threshold value (e.g., a high security score) may be sent to the application 134 via one of the application-aware path(s) 204. Additionally, traffic having a security score that is less than the threshold value (e.g., a low security score) and/or between a first threshold value and a second threshold value (e.g., a medium security score) may be sent to the application 134 via the alternative path 208. In some examples, the path(s) chosen even when a security score is not a high security score may still be an application-aware path, but the path may include some form of security measures. That is, one of the application-aware path(s) 204 may include a security function/service, even though not illustrated as such in FIG. 2.

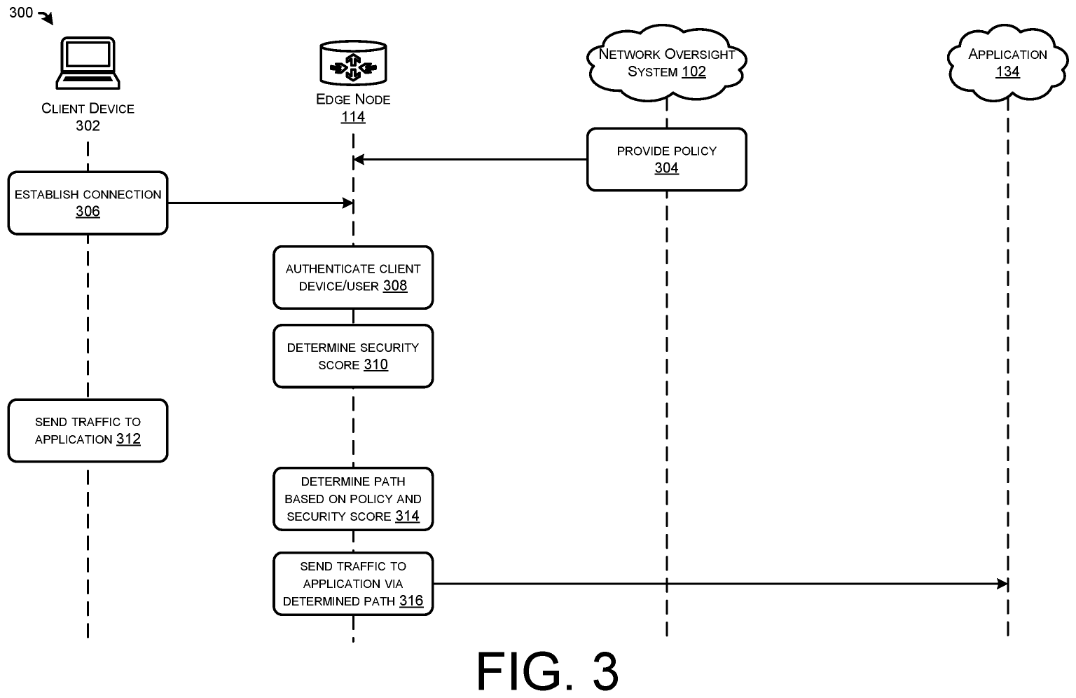

FIG. 3 is a pictorial flow diagram illustrating an example method 300 associated with the techniques described herein. The logical operations (e.g., operations 304-316) described herein with respect to FIG. 3 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 3 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

At operation 304, the method 300 includes the network oversight system 102 providing a policy (e.g., the policy 110) to the edge node 114. The policy may be a routing policy that defines routing actions to be taken for specific application traffic having various security scores and/or traffic signatures. At operation 306, the method 300 includes the client device 302 establishing a connection with the edge node 114.

At operation 308, the method 300 includes the edge node authenticating the client device 302 and/or a user of the client device 302. For instance, the edge node 114 (or a headend) may invoke an identity provider to authenticate/authorize the client device 302. At operation 310, the method 300 may include the edge node 114 determining a security score associated with the traffic that is to be sent by the client device 302. For instance, the security score may be indicative of a security posture of the client device 302, a security level of a network utilized by the client device 302 to connect, or the like. In some examples, the edge node 114 may receive the security score from the identity provider.

At operation 312, the method 300 includes the client device 302 sending traffic to the application 134. For instance, the traffic may be routed to the edge node 114, and the edge node may be configured to route the traffic to the application 134. At operation 314, the method 300 includes determining, by the edge node 114, a path to send the traffic to the application 134 based on the policy and the security score. For instance, the edge node 114 may determine whether to send the traffic to the application 134 over an application-aware path or to use an alternative path that includes a security function/service. At operation 316, the method 300 includes the edge node 114 sending the traffic to the application 134 via the determined path.

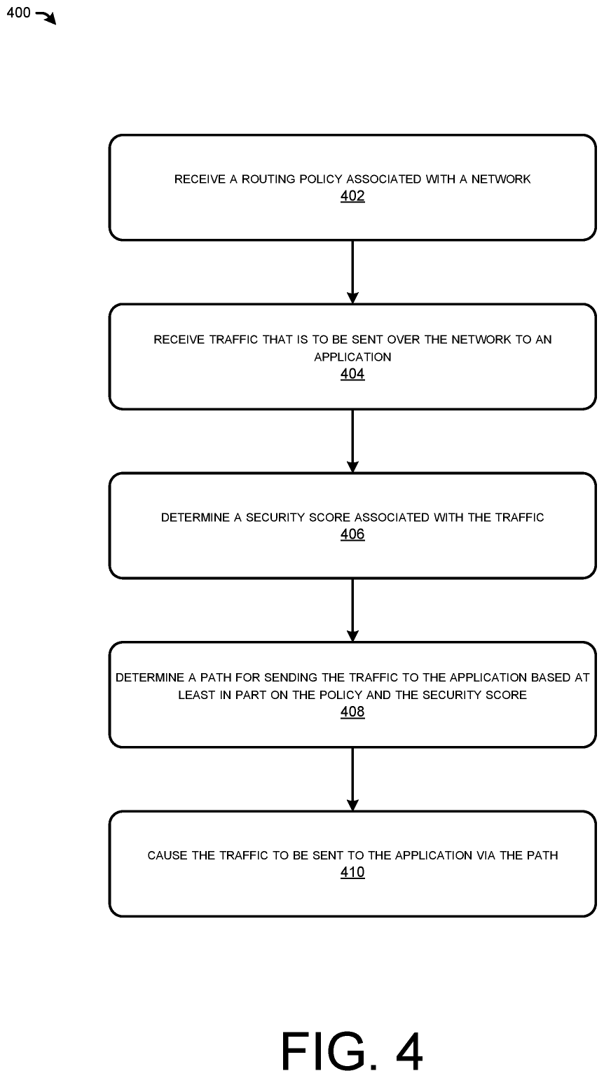

FIG. 4 is a flow diagram illustrating an example method associated with the techniques described herein. As noted above with respect to FIG. 3, the logical operations (e.g., operations 402-410) described herein with respect to FIG. 4 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 4 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

The method 400 begins at operation 402, which includes receiving a routing policy associated with a network. For instance, the edge node 114 may receive the policy 110 from the management plane 104 of the network oversight system 102. The policy may be an AAR policy that is extended to enable intelligent routing decisions based on device security posture and/or the security level of the network used to connect.

At operation 404, the method 400 includes receiving traffic that is to be sent over the network to an application. For instance, the edge node 114 may receive the traffic 126 that is to be sent over the branch network 108 and/or over a wide area network to the application 134. In some examples, the traffic 126 may originate from a remote access client device, a managed client device, an unmanaged client device, or the like.

At operation 406, the method 400 includes determining a security score associated with the traffic. For instance, the edge node 114 may lookup an IP address or user/device identifier included in the traffic 126 to determine the security score 112 associated with the traffic 126. In some examples, an identity provider may generate the security score and distribute it to the network oversight system and/or the edge node. In some examples, the security score may be associated or linked to the IP address and/or user/device identifier such that the edge node may look up the security score when it is determining how to route the traffic.

At operation 408, the method 400 includes determining a path for sending the traffic to the application based at least in part on the policy and the security score. For instance, the edge node 114 may determine whether to send the traffic 126 to the application 134 via an application-aware path 204 or to send the traffic 126 to the application 134 via the alternative path 208 that includes the security function/service 138. In some examples, the path is determined by the edge node based at least in part on one or more of the policy, the security score, and/or a traffic signature associated with the traffic. At operation 410, the method 400 includes causing the traffic to be sent to the application via the path.

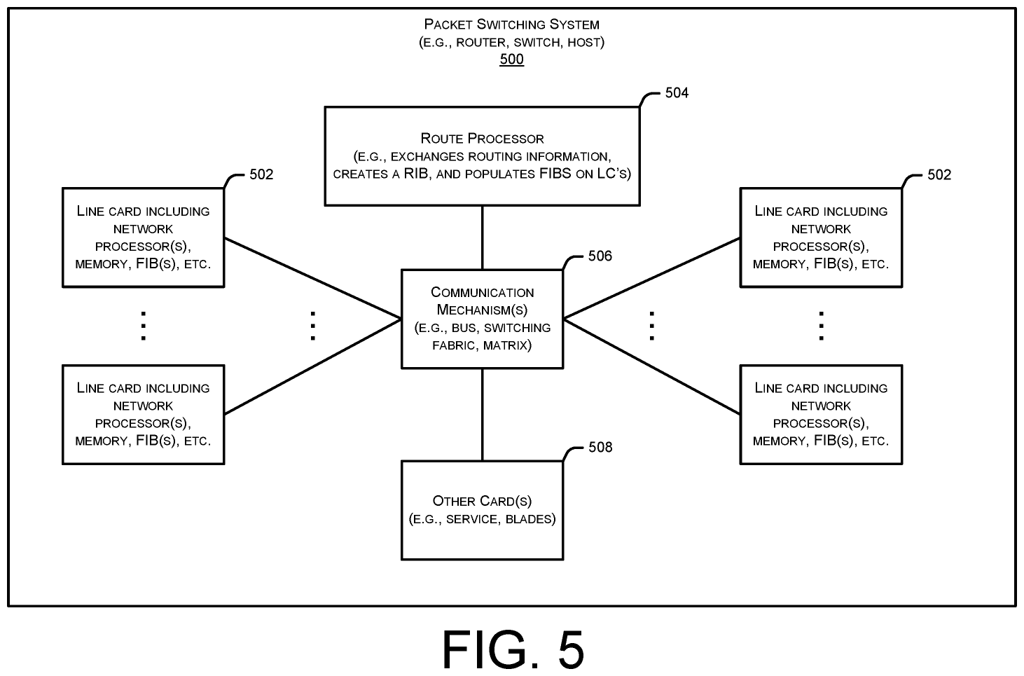

FIG. 5 is a block diagram illustrating an example packet switching device 500 (or packet switching system) that can be utilized to implement various aspects of the technologies disclosed herein. In some examples, packet switching device(s) 500 may be employed in various networks and architectures, such as, for example, the architectures 100 and 200 described with respect to FIGS. 1 and 2. For instance, the edge node 114 in FIGS. 1 and 2 may include similar components as the packet switching device 500.

In some examples, the packet switching device 500 may comprise multiple line card(s) 502, 510, each with one or more network interfaces for sending and receiving packets over communications links (e.g., possibly part of a link aggregation group). The packet switching device 500 may also have a control plane with one or more route processor 504 elements for managing the control plane and/or control plane processing of packets associated with forwarding of packets in a network, including, but not limited to, exchanging routing information, creating routing information base(s) (RIBs), and/or populating forward information base(s) (FIBs) on LCs. The packet switching device 500 may also include other cards 508 (e.g., service cards, blades) which include processing elements that are used to process (e.g., forward/send, drop, manipulate, change, modify, receive, create, duplicate, apply a service) packets associated with forwarding of packets in a network. The packet switching device 500 may comprise hardware-based communication mechanism 506 (e.g., bus, switching fabric, and/or matrix, etc.) for allowing its different entities to communicate. Line card(s) 502, 510 may typically perform the actions of being both an ingress and/or an egress line card 502, 510, in regard to multiple other particular packets and/or packet streams being received by, or sent from, packet switching device 500.

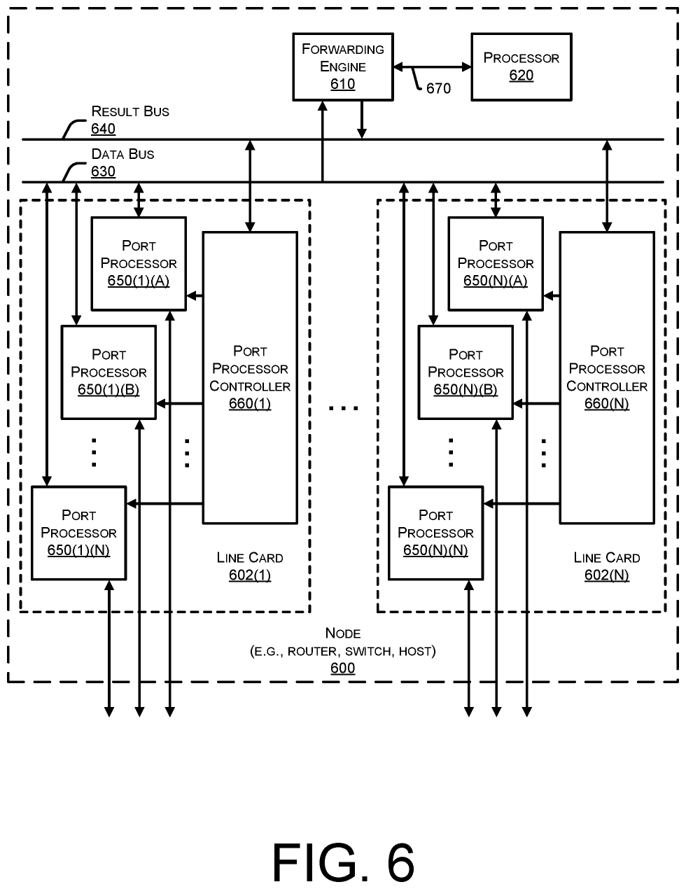

FIG. 6 is a block diagram illustrating certain components of an example node 600 that can be utilized to implement various aspects of the technologies disclosed herein. In some examples, node(s) 600 may be employed in various architectures and networks, such as, for example, the architectures 100 and 200 described with respect to FIGS. 1 and 2.

In some examples, the node 600 may include any number of line cards 602 (e.g., line cards 602(1)-(N), where N may be any integer greater than 1) that are communicatively coupled to a forwarding engine 610 (also referred to as a packet forwarder) and/or a processor 620 via a data bus 630 and/or a result bus 640. Line cards 602(1)-(N) may include any number of port processors 650(1)(A)-(N)(N) which are controlled by port processor controllers 660(1)-(N). where N may be any integer greater than 1. Additionally, or alternatively, forwarding engine 610 and/or processor 620 are not only coupled to one another via the data bus 630 and the result bus 640, but may also communicatively coupled to one another by a communications link 670.

The processors (e.g., the port processor(s) 650 and/or the port processor controller(s) 660) of each line card 602 may be mounted on a single printed circuit board. When a packet or packet and header are received, the packet or packet and header may be identified and analyzed by node 600 (also referred to herein as a router) in the following manner. Upon receipt, a packet (or some or all of its control information) or packet and header may be sent from one of port processor(s) 650(1)(A)-(N)(N) at which the packet or packet and header was received and to one or more of those devices coupled to the data bus 630 (e.g., others of the port processor(s) 650(1)(A)-(N)(N), the forwarding engine 610 and/or the processor 620). Handling of the packet or packet and header may be determined, for example, by the forwarding engine 610. For example, the forwarding engine 610 may determine that the packet or packet and header should be forwarded to one or more of port processors 650(1)(A)-(N)(N). This may be accomplished by indicating to corresponding one(s) of port processor controllers 660(1)-(N) that the copy of the packet or packet and header held in the given one(s) of port processor(s) 650(1)(A)-(N)(N) should be forwarded to the appropriate one of port processor(s) 650(1)(A)-(N)(N). Additionally, or alternatively, once a packet or packet and header has been identified for processing, the forwarding engine 610, the processor 620, and/or the like may be used to process the packet or packet and header in some manner and/or maty add packet security information in order to secure the packet. On a node 600 sourcing such a packet or packet and header. this processing may include. for example, encryption of some or all of the packet's and/or header's information, the addition of a digital signature, and/or some other information and/or processing capable of securing the packet or packet and header. On a node 600 receiving such a processed packet or packet and header, the corresponding process may be performed to recover or validate the packet's and/or header's information that has been secured.

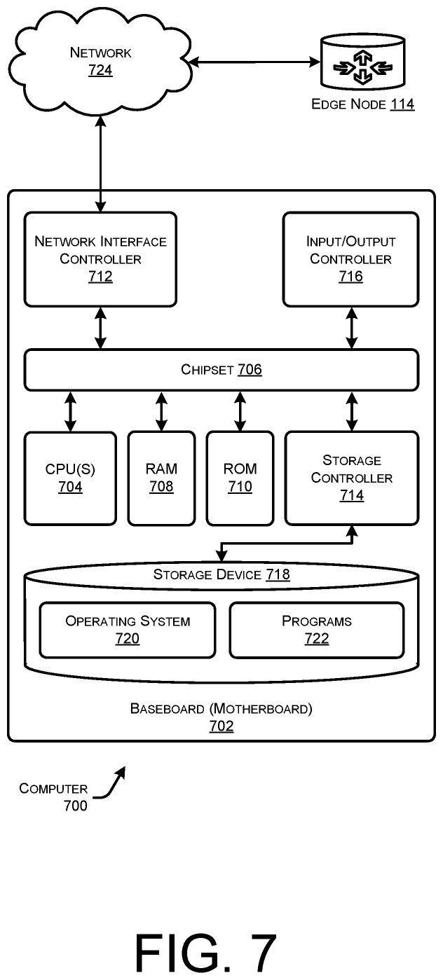

FIG. 7 is a computer architecture diagram showing an illustrative computer hardware architecture for implementing a computing device that can be utilized to implement aspects of the various technologies presented herein. The computer architecture shown in FIG. 7 may be illustrative of a conventional server computer, edge node 114, router, switch, workstation, desktop computer, laptop, tablet, network appliance, e-reader, smartphone, load balancer, or other computing device, and can be utilized to execute any of the software components presented herein.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer 700. The chipset 706 can further provide an interface to a computer-readable storage medium such as a read-only memory (“ROM”) 710 or non-volatile RAM (“NVRAM”) for storing basic routines that help to startup the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network. The chipset 706 can include functionality for providing network connectivity through a NIC 712, such as a gigabit Ethernet adapter. The NIC 712 is capable of connecting the computer 700 to other computing devices over the network 724, such as the edge node 114. It should be appreciated that multiple NICs 712 can be present in the computer 700, connecting the computer to other types of networks and remote computer systems. In some examples, the NIC 712 may be configured to perform at least some of the techniques described herein.

The computer 700 can be connected to a storage device 718 that provides non-volatile storage for the computer. The storage device 718 can store an operating system 720, programs 722, and data, which have been described in greater detail herein. The storage device 718 can be connected to the computer 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computer 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 718 by detecting the physical states or characteristics of one or more particular locations within the physical storage units.

In addition to the mass storage device 718 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations performed by the architectures 100, 200, and or any components included therein, may be supported by one or more devices similar to computer 700. Stated otherwise, some or all of the operations performed by the architectures 100, 200, and or any components included therein, may be performed by one or more computer devices 700 operating in a scalable arrangement.

By way of example, and not limitation, computer-readable storage media can include volatile and non-volatile, removable, and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 700.

In one embodiment, the storage device 718 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes and functionality described above with regard to FIGS. 1-4, and herein. The computer 700 can also include computer-readable storage media having instructions stored thereupon for performing any of the other computer-implemented operations described herein.

The computer 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

The computer 700 may include one or more hardware processors (processors) configured to execute one or more stored instructions. The processor(s) may comprise one or more cores. Further, the computer 700 may include one or more network interfaces configured to provide communications between the computer 700 and other devices. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 722 may comprise any type of programs or processes to perform the techniques described in this disclosure for extending application-aware routing policies to enable intelligent routing decisions based on device security posture and/or the security level of the network used to connect.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving an application-aware routing policy associated with a network;
receiving, from a client device, traffic that is to be sent over the network to an application;
determining a security score associated with the traffic;
determining, based at least in part on the security score and based at least in part on the application-aware routing policy, a path for sending the traffic to the application; and
causing the traffic to be sent to the application via the path.

2. The method of claim 1, wherein the security score is based at least in part on a security posture of the client device.

3. The method of claim 1, wherein the security score is based at least in part on a security level of a connectivity network of the client device.

4. The method of claim 1, further comprising determining a traffic signature associated with the traffic, wherein determining the path for sending the traffic to the application is further based at least in part on the traffic signature associated with the traffic.

5. The method of claim 1, wherein a value of the security score is based at least in part on at least one of:
whether the client device is a trusted device or an untrusted device, or
whether the client device is utilizing a private network or a public network.

6. The method of claim 1, further comprising determining that a value of the security score meets or exceeds a threshold value, wherein the path is a direct path for sending the traffic to the application.

7. The method of claim 1, further comprising determining that a value of the security score is less than a threshold value, wherein the path for sending the traffic to the application includes a cloud-delivered security service.

8. The method of claim 1, wherein the security score associated with the traffic is at least partially determined using an identity provider service.

9. A system comprising:
one or more processors; and
one or more non-transitory computer-readable media storing instructions that, when executed, cause the one or more processors to perform operations comprising:
receiving an application-aware routing policy associated with a network;
receiving, from a client device, traffic that is to be sent over the network to an application;
determining a security score associated with the traffic;
determining, based at least in part on the security score and based at least in part on the application-aware routing policy, a path for sending the traffic to the application; and
causing the traffic to be sent to the application via the path.

10. The system of claim 9, wherein the security score is based at least in part on a security posture of the client device.

11. The system of claim 9, wherein the security score is based at least in part on a security level of a connectivity network of the client device.

12. The system of claim 9, the operations further comprising determining a traffic signature associated with the traffic, wherein determining the path for sending the traffic to the application is further based at least in part on the traffic signature associated with the traffic.

13. The system of claim 9, wherein a value of the security score is based at least in part on at least one of:
whether the client device is a trusted device or an untrusted device, or
whether the client device is utilizing a private network or a public network.

14. The system of claim 9, the operations further comprising determining that a value of the security score meets or exceeds a threshold value, wherein the path is a direct path for sending the traffic to the application.

15. The system of claim 9, the operations further comprising determining that a value of the security score is less than a threshold value, wherein the path for sending the traffic to the application includes a cloud-delivered security service.

16. The system of claim 9, wherein the security score associated with the traffic is at least partially determined using an identity provider service.

17. One or more non-transitory computer-readable media storing instructions that, when executed, cause one or more processors to perform operations comprising:
receiving an application-aware routing policy associated with a network;
receiving, from a client device, traffic that is to be sent over the network to an application;
determining a security score associated with the traffic;
determining, based at least in part on the security score and based at least in part on the application-aware routing policy, a path for sending the traffic to the application; and
causing the traffic to be sent to the application via the path.

18. The one or more non-transitory computer-readable media of claim 17, wherein the security score is based at least in part on a security posture of the client device.

19. The one or more non-transitory computer-readable media of claim 17, wherein the security score is based at least in part on a security level of a connectivity network of the client device.

20. The one or more non-transitory computer-readable media of claim 17, the operations further comprising determining a traffic signature associated with the traffic, wherein determining the path for sending the traffic to the application is further based at least in part on the traffic signature associated with the traffic.
